(19) United States
(12) Patent Application Publication
(10) Pub. No.: US 2015/0020175 A1
(43) Pub. Date: Jan. 15, 2015

(54) ACCOUNT LOGIN METHOD, APPARATUS AND SYSTEM, AND NETWORK SERVER

(71) Applicant: TENCENT TECHNOLOGY (SHENZHEN) COMPANY LIMITED, Shenzhen (CN)

(72) Inventors: Liu YANG, Shenzhen (CN); Sha MO, Shenzhen (CN); Sirui LIU, Shenzhen (CN); Yan LI, Shenzhen (CN)

(21) Appl. No.: 14/499,955

(22) Filed: Sep. 29, 2014

Related U.S. Application Data
(63) Continuation of application No. PCT/CN2012/087717, filed on Dec. 27, 2012.

(30) Foreign Application Priority Data
Mar. 31, 2012 (CN) 201210093211.5

(51) Int. Cl. H04L 29/06

(52) U.S. Cl. CPC H04L 63/10; H04L 63/083
USPC 726/5

(57) ABSTRACT

The examples of the present disclosure provide an account login method, device and system and a network server, which relate to computer communications. The method includes: obtaining current fingerprint information sent from a terminal; determining whether the current fingerprint information is the same with pre-stored initial fingerprint information; and allowing the terminal to log in to an account which is associated with a piece of the pre-stored initial fingerprint information when the current fingerprint information is the same with the piece of the pre-stored initial fingerprint information. By determining whether the received current fingerprint information has existed, and allowing the terminal to log in to an account which is associated with the initial fingerprint information if the current fingerprint information has existed, the method realizes login to an account only by a fingerprint, which avoids the complicated process during login to an internet application and improves the user experience.

### CROSS-REFERENCE TO RELATED APPLICATIONS

This application is a continuation application of PCT Patent Application No. PCT/CN2012/087717, entitled “Account Login Method, Apparatus and System, and Network Server” filed on Dec. 27, 2012, which claims priority to Chinese Patent Application No. 201210093211.5, entitled “Account Login Method, Apparatus and System, and Network Server” filed on Mar. 31, 2012, both of which are incorporated by reference in their entirety.

### TECHNICAL FIELD

The present invention relates to computer communications and particularly to an account login method, apparatus and system, and a network server.

### BACKGROUND

With booming development of internet technologies, various kinds of terminals can communicate with each other through the internet. Currently, an internet account (e.g., a browser account, a chat application account, etc.) on a terminal is logged in to by entering a user name and a password.

In an account login method in existing technologies, first user name and password input boxes of an internet application are shown on an interface of a terminal, then characters inputted into the user name and password input boxes by a user are received, then the terminal sends the characters to a corresponding network server via the internet, and the network server verifies the user name and the password, and if the user name and the password are correct, the internet application on the terminal is controlled to log in to the account.

However the inventor finds that at least following problems exist in the existing technology when realizing the present disclosure.

When a user logs in to the internet application, he needs to enter corresponding user name and password into the user name and password input boxes; however generally entering a user name and a password needs multiple clicks on a screen of the terminal by a user, the whole procedure is slow and complicated, and during the operation of a touch screen of the terminal, a false input operation may occur, which further adds operation steps of the user and greatly lowers the user experience.

### SUMMARY

To avoid the complicated process during login to an internet application and improves the user experience, examples of the present disclosure provide an account login method, device and system and a network server. The technical scheme includes the following process.

According to an aspect of the present disclosure, the present disclosure provides an account login method. The method includes the following process:

obtaining current fingerprint information sent from a terminal;

determining whether the current fingerprint information is the same with pre-stored initial fingerprint information; and

allowing the terminal to log in to an account which is associated with a piece of the pre-stored initial fingerprint information when the current fingerprint information is the same with the piece of the pre-stored initial fingerprint information.

Before obtaining the current fingerprint information sent from the terminal, the method further includes:

obtaining the account to be logged in to and a password sent from the terminal;

verifying whether the account and the password are correct and whether the account is associated with any fingerprint information;

guiding the terminal to enter the initial fingerprint information for the account and obtaining the initial fingerprint information, if it is confirmed that the account and the password are correct and the account is not associated with any fingerprint information; and

associating and storing the account with the obtained initial fingerprint information, when the obtained initial fingerprint information is not the same with all the pre-stored fingerprint information.

Before obtaining the current fingerprint information sent from the terminal, the method further includes:

obtaining the account to be logged in to, a password and the initial fingerprint information sent from the terminal; and

associating and storing the account with the initial fingerprint information, if it is confirmed that the account and the password are correct and the account is not associated with any fingerprint information and that the initial fingerprint information is not the same with all the pre-stored fingerprint information.

Further, the pre-stored initial fingerprint information and the associated account are one-to-one correspondence.

According to another aspect of the present disclosure, the present disclosure provides an account login apparatus and the apparatus includes:

a first obtaining module, to obtain current fingerprint information sent from a terminal;

a determination module, to determine whether the current fingerprint information is the same with pre-stored initial fingerprint information; and

a login module, to allow the terminal to log in to an account which is associated with a piece of the pre-stored initial fingerprint information when the determination module determines that the current fingerprint information is the same with the piece of the pre-stored initial fingerprint information.

Further, the apparatus includes:

a second obtaining module, to obtain the account to be logged in to and a password sent from the terminal;

a third obtaining module, to guide the terminal to enter the initial fingerprint information for the account and obtain the initial fingerprint information, if it is confirmed that the account and the password are correct and the account is not associated with any fingerprint information; and

a first associating module, to associate and store the account with the obtained initial fingerprint information, when the obtained initial fingerprint information is not the same with all the pre-stored fingerprint information.

Further, the apparatus includes:

a fourth obtaining module, to obtain the account to be logged in to, a password and the initial fingerprint information sent from the terminal; and

a second associating module, to associate and store the account with the initial fingerprint information, if it is confirmed that the account and the password are correct and the account is not associated with any fingerprint information and that the initial fingerprint information is not the same with all the pre-stored fingerprint information.

Further, the pre-stored initial fingerprint information and the associated account are one-to-one correspondence.

According to still another aspect of the present disclosure, the present disclosure also provides a network server, and the network server includes the above account login apparatus.

According to still another aspect, the present disclosure also provides an account login system, and the system includes a terminal and the above network server.

The technical scheme provided in the examples of the present disclosure has the following benefits:

by determining whether the received current fingerprint information exists, and allowing the terminal to log in to an account which is associated with the initial fingerprint information if the current fingerprint information exists, the technical scheme realizes login to an account only by a fingerprint, which avoids the complicated process during login to an internet application and improves the user experience.

### BRIEF DESCRIPTION OF THE DRAWINGS

For a better understanding of the technical scheme in the examples of the present disclosure, brief description will be made below for the figures necessary in the examples. Obviously, the figures described below are just some examples of the present disclosure and an ordinary skilled in the art can obtain other figures through these figures without any creative efforts.

FIG. 1 shows a schematic diagram of an environment for implementing an account login method provided in examples of the present disclosure;

FIG. 2 shows a schematic flowchart of an account login method provided in Example 1 of the present disclosure;

FIG. 3 shows a schematic flowchart of an account login method provided in Example 2 of the present disclosure;

FIG. 4 shows a schematic flowchart of an account login method provided in Example 3 of the present disclosure;

FIG. 5 shows a structural schematic diagram of an account login apparatus provided in Example 4 of the present disclosure;

FIG. 6 shows a structural schematic diagram of an account login apparatus provided in Example 5 of the present disclosure; and

FIG. 7 shows a structural schematic diagram of an account login system provided in Example 6 of the present disclosure.

### DETAILED DESCRIPTION

To show the purpose, technical scheme and benefits of the present invention more clearly, detailed description of the present invention is further made as follows.

FIG. 1 shows a schematic diagram of an environment for implementing an account login method provided in examples of the present disclosure. The environment includes a terminal 110 and a network server 120.

The terminal 110 may be a terminal that can identify fingerprints, such as a touchscreen phone, a touchscreen computer or a touchscreen game console, etc. For example, when a user's finger touches a touchscreen, a processor inside the terminal 110 may receive fingerprint information generated when the user's finger touches the touchscreen. Generally the terminal 110 contains network applications for account login via the internet, such as browsers, chat applications, etc.

The network server 120 may be a server to verify login to an account of a network application and store therein the account of the network application and a login password corresponding to the account.

Generally, the network server 120 is a server to provide network services and management for the network applications in the terminal 110. Data transmission between the terminal 110 and the network server 120 may be performed via a network and the network may be a wired or wireless one.

### EXAMPLE 1

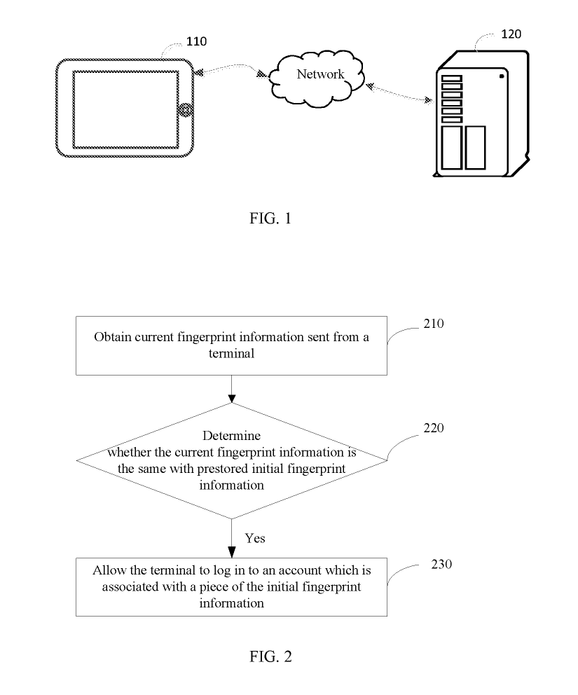

FIG. 2 shows a schematic flowchart of an account login method provided in Example 1 of the present disclosure. A terminal in the account login method can be the terminal 110 shown in FIG. 1 and the account login method can be applied in the network server 120 shown in FIG. 1. The account login method includes the following process.

At block 210, current fingerprint information sent from the terminal is obtained.

Generally, at this point, the terminal 110 can only enter fingerprint information as the current fingerprint information without entering other login information such as an account or a password, etc.

At block 220, it is determined whether the current fingerprint information is the same with pre-stored initial fingerprint information.

The network server 120 usually has stored an account and initial fingerprint information corresponding to the account, and has associated the account with the initial fingerprint information corresponding to the account.

Preferably, an account and initial fingerprint information associated therewith are one-to-one correspondence in the network server 120. That is, one account is only associated with unique initial fingerprint information and the initial fingerprint information is uniquely associated with the account.

Further, before the initial fingerprint information is associated with the account, it is first guaranteed that the account can be logged in to. In other words, before the initial fingerprint information is associated with the account, first the account and a password corresponding to the account are confirmed, and if the account and the password corresponding to the account are all correct, the initial fingerprint information is associated with the account.

At block 230, if the current fingerprint information is the same with one piece of pre-stored initial fingerprint information, then the terminal is allowed to log in to a pre-stored account which is associated with the initial fingerprint information.

Generally, the network server 120 may pre-store numerous initial fingerprint information and accounts that are associated with each piece of initial fingerprint information. As long as the current fingerprint information is the same with one piece of the pre-stored initial fingerprint information, which means that the fingerprint information has been associated, a pre-stored account associated with the initial fingerprint information is allowed to be logged in to.

Generally, in practice, the user only needs to use fingerprint information to login to an account, and correspondingly the network server 120 may usually make a stored account and initial fingerprint information associated therewith be one-to-one correspondence. In this way, as long as the current fingerprint information is the same with one piece of the pre-stored initial fingerprint information, which means that the fingerprint information has been associated, the unique account associated with the initial fingerprint information is allowed to be logged in to.

In a word, in the account login method provided in Example 1 of the present disclosure, the received current fingerprint information is compared with the pre-stored initial fingerprint information, and if the current fingerprint information is the same with one piece of the pre-stored initial fingerprint information, the terminal is allowed to log in to a pre-stored account associated with the initial fingerprint information, so as to realize account login with only a fingerprint, avoid the complicated process during login of an internet application, and thus improve the user experience.

### EXAMPLE 2

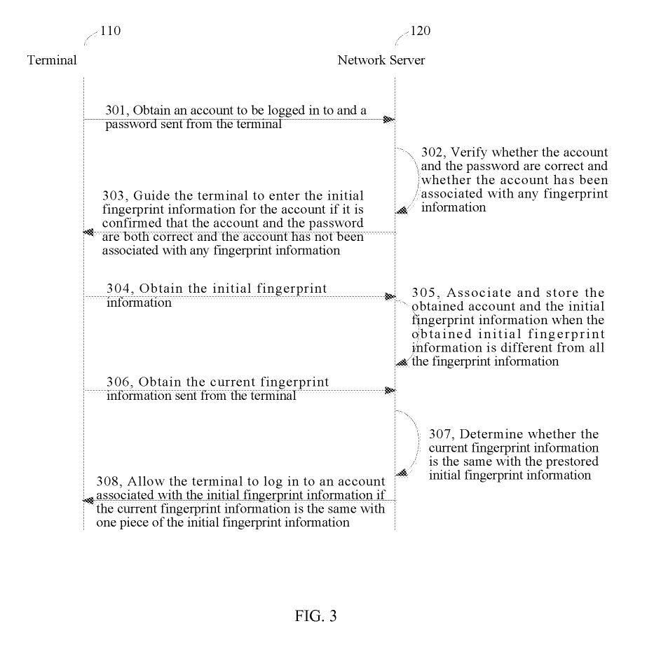

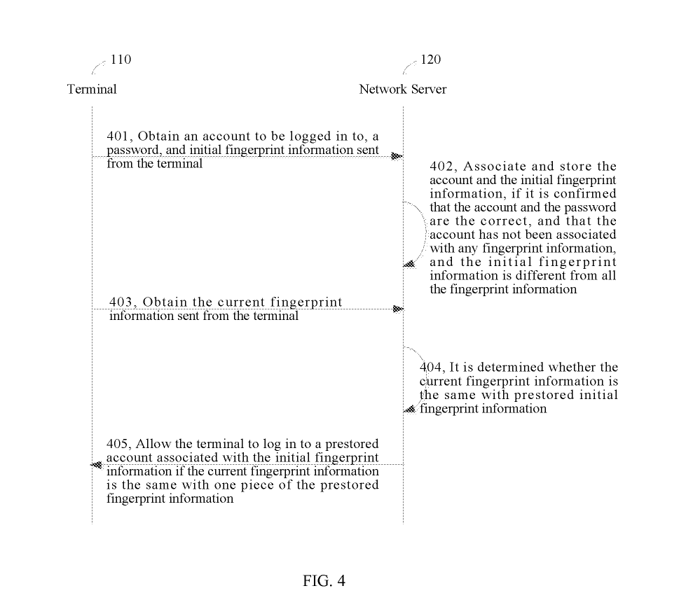

FIG. 3 shows a schematic flowchart of an account login method provided in Example 2 of the present disclosure. A terminal in the account login method may be the terminal 110 shown in FIG. 1 and the account login method may be applied in a network server. Herein the network server may be the network server 120 shown in FIG. 1. The account login method includes the following process.

At block 301, an account to be logged in to and a password sent from the terminal are obtained.

The network server 120 obtains the account to be logged in to and the password sent from the terminal 110, and so far, the terminal 110 hasn't entered fingerprint information for the account or hasn't associated the account with the fingerprint information. In other words, at first the terminal 110 logs in to the account in a normal way.

At block 302, whether the account and the password are correct and whether the account has been associated with any fingerprint information are verified.

At first, the network server 120 confirms whether the obtained account and password are correct. That is, the network server 120 first confirms whether the account exists; then if the account exists, further confirms whether the obtained password is a login password for login to the account; if the password is the login password required for login to the account, then it is confirmed that the account and the password are both correct. Generally, the network server 120 contains valid accounts and passwords corresponding to the accounts stored in the database, and after the network server 120 receives an account and a password, it will match the account and the password in the database, and if they are both successfully matched, then the account and the password are deemed to be correct.

Then the network server 120 confirms whether the account has been associated with fingerprint information, and generally may find out the fingerprint information associated with the account if the account has been associated.

At block 303, if it is confirmed that the account and the password are both correct and the account has not been associated with any fingerprint information, then the terminal is guided to enter the initial fingerprint information for the account.

After the network server 120 confirms that the account and the password are both correct and the account has not been associated with any fingerprint information, then it will send guidance information on whether or not to perform association to the terminal 110. The guidance information will control the terminal 110 to display corresponding prompting information on an interface thereof For example, the prompting information displayed can be “perform fingerprint association or not”, and the user will select to perform the fingerprint association or not according to the prompting information. And if the user performs the fingerprint association, then fingerprint information is entered, and the fingerprint information is used as the initial fingerprint information.

At block 304, the initial fingerprint information is obtained.

When the user enters the initial fingerprint information according to the prompting information, the terminal 110 will send the initial fingerprint information to the network server 120, and correspondingly the network server 120 can obtain the initial fingerprint information.

At block 305, when the obtained initial fingerprint information is different from all the pre-stored fingerprint information, then the account is associated with the initial fingerprint information and stored.

Generally, if a piece of fingerprint information corresponds to multiple accounts, then when the user enters a piece of fingerprint information, multiple accounts may be logged in to, which is not what the user wants. Therefore, in a preferred example, accounts and initial fingerprint information are one-to-one correspondence. That is, an account can only associate with a unique fingerprint, and the fingerprint can only uniquely been associated with the account.

To make the account and the initial fingerprint information be one-to-one correspondence, at first, the network server 120 compares the initial fingerprint information with all pre-stored fingerprint information (i.e., all fingerprint information stored in the network server 120 that have been associated with accounts), and confirms that the initial fingerprint information hasn't been associated if the initial fingerprint information is different from all the pre-stored fingerprint information. And as is known from the block 302, the account has not been associated either. Therefore, the account can be associated with the initial fingerprint information.

By taking the above blocks, the network server 120 may store the account, the initial fingerprint information associated with the account and the correct password corresponding to the account.

At block 306, the current fingerprint information sent from the terminal is obtained.

The current fingerprint information is fingerprint information newly entered by the user. The current fingerprint information and the initial fingerprint information mentioned herein may be entered from different terminals.

At block 307, it is determined whether the current fingerprint information is the same with the pre-stored initial fingerprint information.

The network server 120 so far has stored the account and the initial fingerprint information corresponding to the account and the network server 120 has associated the account with the initial fingerprint information corresponding to the account.

It is known from the above blocks that the account and the initial fingerprint information associated therewith are one-to-one correspondence in the network server 120. That is, an account is only associated with unique initial fingerprint information and the initial fingerprint information is only associated with the account too.

At block 308, if the current fingerprint information is the same with one piece of initial fingerprint information, then the terminal is allowed to log in to a pre-stored account associated with the piece of the initial fingerprint information.

Since the network server 120 may have pre-stored numerous initial fingerprint information and pre-stored accounts that are associated with the initial fingerprint information, as long as the current fingerprint information is the same with one piece of the pre-stored initial fingerprint information, which means that the fingerprint information has been associated, a pre-stored account that is associated with the piece of the initial fingerprint information is allowed to be logged in to.

In summary, in the account login method provided in Example 2 of the present disclosure, after the account is successfully logged in to, at first the terminal is guided to enter initial fingerprint information associated with the account, and the initial fingerprint information is obtained and is associated with the corresponding account. When current fingerprint information is obtained again, only the current fingerprint information and the initial fingerprint information need to be compared to see whether they are same, and if they are same, then the account can be logged in to directly. After the account is associated with the fingerprint information, when the terminal logs in to the account, only the fingerprint information needs to be entered, which avoids the complicated process during the account login and improves the user experience.

### EXAMPLE 3

FIG. 4 shows a schematic flowchart of an account login method provided in Example 3 of the present disclosure. A terminal in the account login method can be the terminal 110 shown in FIG. 1, and the account login method can be applied in the network server. The network server can be the network server 120 in FIG. 1. The account login method includes the following process.

At block 401, an account to be logged in to, a password and initial fingerprint information sent from the terminal are obtained.

In other words, while logging in to the account, the terminal 110 at the same time sends the initial fingerprint information to the network server 120.

At block 402, if it is confirmed that the account and the password are correct and the account has not been associated with any fingerprint information, and that the initial fingerprint information is different from all the pre-stored fingerprint information, then the account and the initial fingerprint information are associated and stored.

After it is confirmed that the account and the password are correct, this indicates that the account exists in the network server 120 and the login password for the account to log in is correct too, therefore the account can be logged in to validly.

Then it is determined whether the account has been associated with any fingerprint information, and if the account has not associated with any fingerprint information, then it is determined whether the initial fingerprint information obtained at block 401 is the same with any fingerprint information in the network server 120.

If the initial fingerprint information is not the same with all the pre-stored fingerprint information (i.e., all fingerprint information associated with the accounts that have been stored in the network server 120), which indicates that the initial fingerprint information hasn't been associated and meanwhile the obtained account hasn't been associated, thus the account can be associated with the initial fingerprint information.

By taking the above blocks, the associated account and initial fingerprint information are one-to-one correspondence. That is, each account is only associated with unique initial fingerprint information and the initial fingerprint information is associated uniquely with the account.

At block 403, current fingerprint information sent from the terminal is obtained.

The current fingerprint information is the fingerprint information newly entered by the user. The current fingerprint information and the initial fingerprint information mentioned herein may be entered from different terminals.

At block 404, it is determined whether the current fingerprint information is the same with pre-stored initial fingerprint information.

The network server 120 so far has stored the account and the initial fingerprint information corresponding to the account and associated the account with the initial fingerprint information corresponding to the account.

It is known from the above blocks that the account and the initial fingerprint information associated therewith are one-to-one correspondence in the network server 120. That is, an account only corresponds to unique initial fingerprint information and the initial fingerprint information associates uniquely with the account.

At block 405, if the current fingerprint information is the same with one piece of the pre-stored initial fingerprint information, the terminal is allowed to log in to a pre-stored account associated with the piece of the initial fingerprint information.

Since the network server 120 may have pre-stored numerous initial fingerprint information and accounts associated with every piece of the initial fingerprint information (i.e., every piece of fingerprint information in the network server 120 that has been associated with an account). As long as the current fingerprint information is the same with one piece of the pre-stored initial fingerprint information, it means that the fingerprint information has been associated and the pre-stored account associated with the initial fingerprint information is allowable to be logged in to.

In conclusion, with the account login method provided in Example 3 of the present disclosure, when an account is to be logged in to, first the account, a corresponding password, and initial fingerprint information are sent from the terminal at the same time; second when it is confirmed that the account and the password are the correct and that the account has not been associated, then it is determined whether the initial fingerprint information exists, and if it does not exist, then the account and the initial fingerprint information can be associated directly, and when the current fingerprint information is obtained again, only the current fingerprint information and the initial fingerprint information need to be compared to see whether they are same, and if they are same, then the account can be logged in to directly. In this way, after the account is associated with the fingerprint information, when the terminal logs in to the account, only the fingerprint information needs to be entered, which avoids the complicated process during the account login and improves the user experience.

### EXAMPLE 4

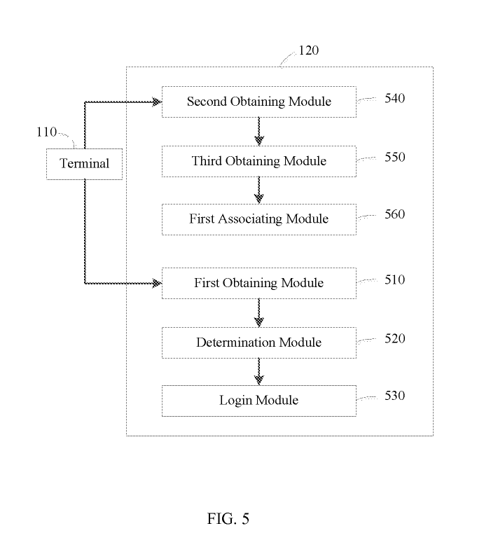

FIG. 5 shows a structural schematic diagram of an account login apparatus provided in Embodiment 4 of the present disclosure. The account login apparatus can be incorporated into the network server 120. The account login apparatus may include a first obtaining module 510, a determination module 520 and a login module 530.

The first obtaining module 510 can be adapted to obtain the current fingerprint information sent from the terminal.

The determination module 520 can be adapted to determine whether the current fingerprint information is the same with the pre-stored initial fingerprint information.

The login module 530 can be adapted to determine at the determination module 520 that the current fingerprint information is the same with one piece of the pre-stored initial fingerprint information, and allow the terminal to log in to a pre-stored account associated with the initial fingerprint information.

The pre-stored initial fingerprint information and an account associated therewith are one-to-one correspondence.

Preferably, the account login apparatus may also include a second obtaining module 540, a third obtaining module 550 and a first associating module 560.

The second obtaining module 540 can be adapted to obtain the account to be logged in to and a password sent from the terminal.

The third obtaining module 550 can be adapted to guide the terminal to enter the initial fingerprint information for the account and obtain the initial fingerprint information, if it is confirmed that the account and the password are correct and the account has not associated with any fingerprint information.

The first associating module 560 can be adapted to associate and store the account with the obtained initial fingerprint information when the obtained initial fingerprint information is different from all the pre-stored fingerprint information.

It is to be noted that the above division of the respective functional modules is only used as an example to illustrate the account login of the account login apparatus provided by the above example. However, in practice, the above functions can be allocated to different functional modules to carry out as needed. That is, the inner structure of the network server is divided into different functional modules to carry out the above described all or part of functions. Further, the account login apparatus provided in the above example and the account login method in Example 2 belong to a same idea, and for detailed implementation thereof please refer to the method in Example 2 and will not be elaborated herein any more.

In summary, with the account login apparatus provided in Example 4 of the present disclosure, after an account is successfully logged in to, at first the terminal is guided to enter initial fingerprint information associated with the account, and the initial fingerprint information is obtained and is associated with the corresponding account. When the current fingerprint information is obtained again, only the current fingerprint information and the initial fingerprint information need to be compared to see whether they are same. And if they are same, then the account can be logged in to directly. In this way, after the account is associated with the fingerprint information, when the terminal logs in to the account, only the fingerprint information needs to be entered, which avoids the complicated process during the account login and improves the user experience.

### EXAMPLE 5

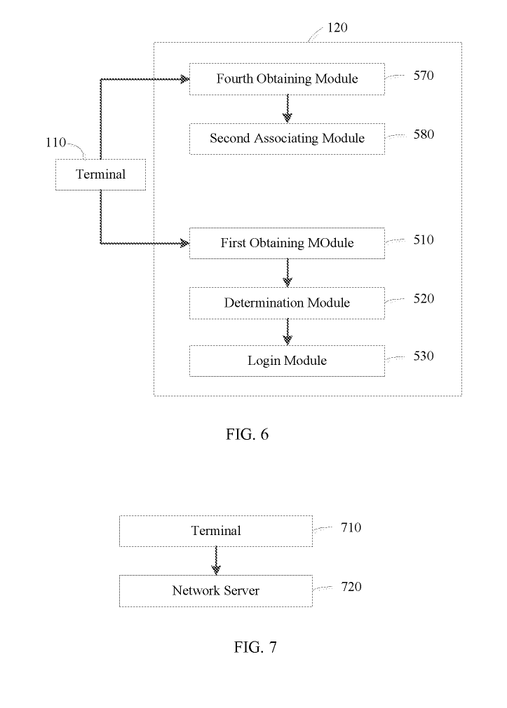

FIG. 6 shows a structural diagram of an account login apparatus provided in Example 5 of the present disclosure. The account login apparatus may be incorporated into the network server 120 shown in FIG. 1. The account login apparatus may include a first obtaining module 510, a determination module 520 and a login module 530.

The first obtaining module 510 can be adapted to obtain current fingerprint information sent from a terminal.

The determination module 520 can be adapted to determine whether the current fingerprint information is the same with pre-stored initial fingerprint information.

The login module 530 can be adapted to allow the terminal to log in to a pre-stored account which is associated with a piece of the initial fingerprint information, if the first determination module determines that the current fingerprint information is the same with one piece of the pre-stored initial fingerprint information.

Herein the pre-stored initial fingerprint information and the pre-stored account associated therewith are one-to-one correspondence and the pre-stored account is associated with a correct password.

Preferably, the account login apparatus may also include a fourth obtaining module 570 and a second associating module 580.

The fourth obtaining module 570 can be adapted to obtain the account to be logged in to, a password and the initial fingerprint information sent from the terminal.

The second associating module 580 can be adapted to associate and store the account with the initial fingerprint information, if it is confirmed that the account and password are correct and the account hasn't been associated with any fingerprint information, meanwhile the initial fingerprint information is different from all the pre-stored fingerprint information.

It is to be noted that the above division of the respective functional modules is only used as an example to illustrate the account login of the account login apparatus provided by the above example. However, in practice, the above functions can be allocated to different functional modules to carry out as needed. That is, the inner structure of the network server is divided into different functional modules to carry out the above described all or part of functions. Further, the account login apparatus provided in the above example and the account login method in Example 3 belong to a same idea, and for detailed implementation thereof please refer to the method in embodiment 3 and will not be elaborated herein any more.

In conclusion, with the account login apparatus provided in Example 5 of the present disclosure, when an account is to be logged in to, at first the account, a corresponding password, and initial fingerprint information sent from the terminal are obtained at the same time; when it is confirmed that the account and the password are correct and that the account has not been associated, then it is confirmed whether the initial fingerprint information exist, and if it does not exist, then the account and the initial fingerprint information can be associated directly, and when the current fingerprint information is obtained again, only the current fingerprint information and the initial fingerprint information need to be compared to see whether they are same. If they are same, then the account can be logged in to directly. In this way, after the account is associated with the fingerprint information, when the terminal logs in to the account, only the fingerprint information needs to be entered, therefore, which avoids the complicated process during the account login and improves the user experience.

### EXAMPLE 6

FIG. 7 shows a structural schematic diagram of an account login system provided in Example 6 of the present disclosure, in which the account login sytem includes a terminal 710 and a network server 720. The terminal 710 may be the terminal 110 shown in FIG. 1, the network server 720 may be the network server 120 shown in FIG. 1, and the network server 720 contains the above account login apparatus.

The account login apparatus may be adapted to obtain current fingerprint information sent from the terminal; determine whether the current fingerprint information is the same with pre-stored initial fingerprint information; and allow the terminal to log in to an account which is associated with a piece of the pre-stored initial fingerprint information, if the current fingerprint information is the same with the piece of the pre-stored initial fingerprint information.

Preferably, the account login apparatus may be also adapted to obtain the account to be logged in to and a password sent from the terminal; verify whether the account and password are correct and whether the account is associated with fingerprint information; guide the terminal to enter the initial fingerprint information for the account and obtain the initial fingerprint information, if it is confirmed that the account and password are correct and the account is not associated with any fingerprint information; and associate and store the account with the initial fingerprint information, when the obtained initial fingerprint information is different from all the pre-stored fingerprint information.

Preferably, the account login apparatus may be further adapted to obtain the account to be logged in to, a password and the initial fingerprint information sent from the terminal; associate the account with the initial fingerprint information and store them, if it is confirmed that the account and password are correct and the account is not associated with any fingerprint information, and meanwhile the initial fingerprint information is different from all the pre-stored fingerprint information.

Preferably, the pre-stored initial fingerprint information and the account associated therewith are one-to-one correspondence.

It is to be specified that, the terminal and the network server in the account login system in above examples have been described in detail in Example 1 to Example 5, and will not be elaborated herein.

It should be understood by those ordinary skilled in the art that the above all or part of the flows in the method examples can be realized by computer programs instructing corresponding hardware and the programs can be stored in computer readable storage media, and when the programs are executed, the flows in the above method examples can be included. The storage media can be a magnetic disc, a disc, a Read-Only Memory or a Random Access Memory, etc.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

What is claimed is:

1. An account login method, comprising:
obtaining current fingerprint information sent from a terminal;
determining whether the current fingerprint information is the same with pre-stored initial fingerprint information; and
allowing the terminal to log in to an account which is associated with a piece of the pre-stored initial fingerprint information when the current fingerprint information is the same with the piece of the pre-stored initial fingerprint information.

2. The method according to claim 1, wherein before obtaining the current fingerprint information sent from the terminal, the method further comprising:
obtaining the account to be logged in to and a password sent from the terminal;
verifying whether the account and the password are correct and whether the account is associated with any fingerprint information;
guiding the terminal to enter the initial fingerprint information for the account and obtaining the initial fingerprint information, if it is confirmed that the account and the password are correct and the account is not associated with any fingerprint information; and
associating and storing the account with the obtained initial fingerprint information, when the obtained initial fingerprint information is different from all the pre-stored fingerprint information.

3. The method according to claim 1, wherein before obtaining the current fingerprint information sent from the terminal, the method further comprising:
obtaining the account to be logged in to, a password and the initial fingerprint information sent from the terminal; and
associating and storing the account with the initial fingerprint information, if it is confirmed that the account and the password are correct and the account is not associated with any fingerprint information and that the initial fingerprint information is different from all the pre-stored fingerprint information.

4. The method according to claim 1, wherein the pre-stored initial fingerprint information and the associated account are one-to-one correspondence.

5. The method according to claim 2, wherein the pre-stored initial fingerprint information and the associated account are one-to-one correspondence.

6. The method according to claim 3, wherein the pre-stored initial fingerprint information and the associated account are one-to-one correspondence.

7. An account login apparatus, comprising:
a first obtaining module, to obtain current fingerprint information sent from a terminal;
a determination module, to determine whether the current fingerprint information is the same with pre-stored initial fingerprint information; and
a login module, to allow the terminal to log in to an account which is associated with a piece of the pre-stored initial fingerprint information when the determination module determines that the current fingerprint information is the same with the piece of the pre-stored initial fingerprint information.

8. The apparatus according to claim 7, further comprising:
a second obtaining module, to obtain the account to be logged in to and a password sent from the terminal;
a third obtaining module, to guide the terminal to enter the initial fingerprint information for the account and obtain the initial fingerprint information, if it is confirmed that the account and the password are correct and the account is not associated with any fingerprint information; and
a first associating module, to associate and store the account with the obtained initial fingerprint information, when the obtained initial fingerprint information is different from all the pre-stored fingerprint information.

9. The apparatus according to claim 7, further comprising:
a fourth obtaining module, to obtain the account to be logged in to, a password and the initial fingerprint information sent from the terminal; and
a second associating module, to associate and store the account with the initial fingerprint information, if it is confirmed that the account and the password are correct and the account is not associated with any fingerprint information and that the initial fingerprint information is different from all the pre-stored fingerprint information.

10. The apparatus according to claim 7, wherein the pre-stored initial fingerprint information and the associated account are one-to-one correspondence.

11. The apparatus according to claim 8, wherein the pre-stored initial fingerprint information and the associated account are one-to-one correspondence.

12. The apparatus according to claim 9, wherein the pre-stored initial fingerprint information and the associated account are one-to-one correspondence.

13. A network server, comprising the apparatus in claim 7.

14. The network server according to claim 13, wherein the apparatus further comprises
a second obtaining module, to obtain the account to be logged in to and a password sent from the terminal;
a third obtaining module, to guide the terminal to enter the initial fingerprint information for the account and obtain the initial fingerprint information, if it is confirmed that the account and the password are correct and the account is not associated with any fingerprint information; and
a first associating module, to associate and store the account with the obtained initial fingerprint information, when the obtained initial fingerprint information is different from all the pre-stored fingerprint information.

15. The network server according to claim 13, wherein the apparatus further comprises
a fourth obtaining module, to obtain the account to be logged in to, a password and the initial fingerprint information sent from the terminal; and
a second associating module, to associate and store the account with the initial fingerprint information, if it is confirmed that the account and the password are correct and the account is not associated with any fingerprint information and that the initial fingerprint information is different from all the pre-stored fingerprint information.

16. The network server according to claim 13, wherein the pre-stored initial fingerprint information and the associated account are one-to-one correspondence.

17. An account login system, comprising a terminal and the network server mentioned in claim 13.

18. The account login system according to claim 17, wherein in the network server, the apparatus further comprises
a second obtaining module, to obtain the account to be logged in to and a password sent from the terminal;
a third obtaining module, to guide the terminal to enter the initial fingerprint information for the account and obtain the initial fingerprint information, if it is confirmed that the account and the password are correct and the account is not been associated with any fingerprint information; and
a first associating module, to associate and store the account with the obtained initial fingerprint information, when the obtained initial fingerprint information is different from all the pre-stored fingerprint information.

19. The account login system according to claim 17, wherein in the network server, the apparatus further comprises
a fourth obtaining module, to obtain the account to be logged in to, a password and the initial fingerprint information sent from the terminal; and
a second associating module, to associate and store the account with the initial fingerprint information, if it is confirmed that the account and the password are correct and the account is not associated with any fingerprint information and that the initial fingerprint information is different from all the pre-stored fingerprint information.

20. The account login system according to claim 17, wherein the pre-stored initial fingerprint information and the associated account are one-to-one correspondence.
